(19) United States
(12) Patent Application Publication
(10) Pub. No.: US 2026/0322756 A1
(43) Pub. Date: Oct. 15, 2026

(54) HANDLING TRANSMISSION OF TSN INFORMATION THROUGH WIRELESS COMMUNICATION NETWORK

(71) Applicant: Telefonaktiebolaget LM Ericsson (publ), Stockholm (SE)

(72) Inventors: Dhruvin PATEL, AACHEN (DE); Joachim SACHS, SOLLENTUNA (SE); János FARKAS, KECSKEMÉT (HU); János HARMATOS, Budapest (HU); Balázs VARGA, BUDAPEST (HU); Marilet De Andrade JARDIM, KISTA (SE); György MIKLÓS, PILISBOROSJENÖ (HU)

(73) Assignee: Telefonaktiebolaget LM Ericsson (publ), Stockholm (SE)

(21) Appl. No.: 19/119,103

(22) PCT Filed: Nov. 7, 2022
(86) PCT No.: PCT/SE2022/051024

§ 371 Date: Apr. 8, 2025

(51) Int. Cl. H04L 47/28; H04L 47/2416; H04L 47/56; H04L 67/12; H04L 69/24

(52) U.S. Cl. CPC H04L 47/28; H04L 47/2416; H04L 47/56; H04L 67/12; H04L 69/24

(57) ABSTRACT

Embodiments of the present disclosure provide a method (500) for transmission of Time-Sensitive Networking, TSN, information through a wireless communication network (80). The wireless communication network (80) operates as a virtual TSN bridge of a TSN system (100). The method (500) is performed by a device side TSN translator, DS-TT (20), associated with one or more User Equipments, UEs (30), connected to a network node (40a) in the wireless communication network (80), or by a network side TSN translator, NW-TT (75), associated with a User Plane Function, UPF (46), of a core network (60) connected to the network node (40a) in the wireless communication network (80). The method (500) comprises identifying (502) one or more TSN streams being received at an ingress port of the DS-TT (20) or the NW-TT (75), each of the one or more TSN streams belonging to a Traffic Class, TC. The method (500) comprises obtaining (504) a maximum delay time interval within the wireless communication network (80) for the TC of the respective identified TSN stream. The method (500) comprises assigning (506) to the respective identified TSN stream, a delay for transmission per TC and port pair from the ingress port to an egress port of the DS-TT (20) or the NW-TT (75), said delay corresponding to the maximum delay time interval of the TC to which the identified TSN stream belongs.

Corresponding DS-TT or NW-TT, and computer program products are also disclosed.

### TECHNICAL FIELD

The present disclosure relates generally to the field of Time Sensitive Networking, TSN, systems. More particularly, it relates to method, a device side TSN translator, DS-TT, or a network side TSN translator, NW-TT, and computer program products for handling transmission of TSN information through wireless communication network to reduce Packet Delay Variation, PDV.

### BACKGROUND

An automation industry is undergoing a digital transformation towards the “Fourth Industrial Revolution” (Industry 4.0), which involves smart manufacturing. Flexible connectivity infrastructure provided by the automation industry is a key enabler for manufacturing to interconnect machines, products and all kinds of other devices in a flexible, secure, and consistent manner.

Communication technology enablers for the digital transformation of the automation industry are Time Sensitive Networking, TSN, system (TSN network) on a wireline side, and a Third Generation Partnership Project, 3GPP, Fifth Generation, 5G, network on a wireless side. The TSN system is based on the Institute of Electrical and Electronics Engineers, IEEE 802.3 Ethernet standard. The TSN system provides deterministic services through IEEE 802. 3 networks, for example, time synchronization, guaranteed low latency transmissions and high reliability. The 5G network, an alternative to a wired connectivity solution supports communication with unprecedented reliability and very low latency, as well as massive Internet of Things, IoT, connectivity. Thus, the TSN system and the 5G network are considered as complementary technologies in providing deterministic communication services, thereby paying the way towards future advanced manufacturing systems and other vertical areas. Also, the TSN system and the 5G network are essential for network convergence that is a support of all kinds of communication services via a same network infrastructure. Therefore, the TSN system can be integrated to the 5G network for supporting the deterministic communication services over heterogeneous infrastructure and multiple application domains required for the network convergence.

With the integration of the TSN system to the 5G network, the 5G network is deployed as a set of IEEE compliant virtual TSN nodes (also be referred to as virtual TSN bridges). The virtual-TSN node can be connected to TSN nodes (also be referred to wired TSN nodes/bridges). The 5G network comprises a 5G core network and a Radio Access Network, RAN. A User Plane Function, UPF, of the 5G core network acts as a gateway to the TSN system. The RAN spans over a production plant to provide wireless connectivity to one or more User Equipments, UEs.

The 5G network/virtual TSN node defines several gateways between the TSN system and the 5G network. The gateways include a TSN Application Function, AF, device side TSN translators, DS-TTs on the UEs, and network side TSN translators, NW-TT on the UPF. The TSN AF connects a Centralized Network Controller, CNC, a Centralized User Configuration, CUC and a 5G control plane.

End-to-end, E2E, time sensitive/deterministic communication provided by the integrated TSN-5G network requires deterministic transmission latency between an ingress port and an egress port (of the DS-TT or the NW-TT). The deterministic transmission latency may be described as an upper bound/maximum allowed packet delay, PD_max, together with a maximum tolerated Packet Delay Variation, PDV. An Ethernet based TSN system can provide a small PDV due to wired connectivity characteristics. A minimum and maximum delay between port pairs of the TSN node are key characteristics for computations to achieve the deterministic transmission latency. However, there are some substantial differences between the 5G network/virtual TSN node and the TSN nodes of the TSN system. One of the differences is that PDV of the 5G network remains considerable higher, for example, 1-2 orders of magnitude compared to the wired TSN nodes where latencies can be controlled at a level of 10's microsecond. Thus, a key challenge in achieving the deterministic transmission latency in the integrated TSN-5G network is higher PDV of the 5G network. In addition, the PDV of the 5G network is too large to practically apply time scheduled transmission/traffic for some time schedule configurations, even though a support for 802.1Qbv has been targeted in the 5G standard. Therefore, to ensure integration and interworking between the TSN system and the 5G network, it is desirable to guarantee a bounded PDV.

A Hold and Forward buffering, H&F, mechanism was conceived in 3GPP (TS 23.501) with a purpose to hold packets (for example, Ethernet frames in the case of the TSN system) in the 5G network for a time between a minimum bound of packet delay, PD_min and maximum bound of packet delay, PD_max before transmission of packets to the next TSN node via an egress port. Therefore, the H&F enables control of PDV. However, how the H&F can be implemented to enable control of PDV is not specified in 3GPP.

### SUMMARY

Since 3GPP does not disclose how to implement the H&F, it remains an open issue how to implement the H&F without standardization, that is without requiring interoperation of ingress (at which TSN streams may be received) and egress ports (at which the TSN streams may be transmitted). The interoperation of the ingress and egress ports may refer to timestamping the TSN streams at the ingress port and, timestamping and measuring time the TSN streams spent in the 5G network/wireless communication network at the egress port.

Consequently, there is a need for an improved method and arrangement for handling transmission of TSN information through a wireless communication network to reduce PDV that alleviates at least some of the above-cited problems.

It is therefore an object of the present disclosure to provide a method, a device side Time-Sensitive Networking, TSN, translator, DS-TT, or a network side TSN translator, NW-TT, and a computer program product for transmission of TSN information through a wireless communication network, to mitigate, alleviate, or eliminate all or at least some of the above-discussed drawbacks of presently known solutions.

This and other objects are achieved by means of a method, a device side Time-Sensitive Networking, TSN, translator, DS-TT, or a network side TSN translator, NW-TT, and a computer program product as defined in the appended claims. The term exemplary is in the present context to be understood as serving as an instance, example or illustration.

According to a first aspect of the present disclose, a method for transmission of Time-Sensitive Networking, TSN, information through a wireless communication network is provided. The wireless communication network operates as a virtual TSN bridge of a TSN system. The method is performed by a device side TSN translator, DS-TT, associated with one or more User Equipments, UEs, connected to a network node in the wireless communication network, or by a network side TSN translator, NW-TT, associated with a User Plane Function, UPF, of a core network connected to the network node in the wireless communication network. The method comprises identifying one or more TSN streams being received at an ingress port of the DS-TT or the NW-TT, each of the one or more TSN streams belonging to a Traffic Class, TC. The method comprises obtaining a maximum delay time interval within the wireless communication network for the TC of the respective identified TSN stream. The method comprises assigning to the respective identified TSN stream, a delay for transmission per TC and port pair from the ingress port to an egress port of the DS-TT or the NW-TT, said delay corresponding to the maximum delay time interval of the TC to which the identified TSN stream belongs.

In some embodiments, the assigned delay corresponding to the maximum delay time interval of the TC per port pair to which the identified TSN stream belongs relates to delay of the TSN stream within the wireless communication network.

In some embodiments, the method further comprises obtaining TSN stream information of the identified one or more TSN streams, the TSN stream information comprising gating information of a first pre-determined scheme and gating information of a second pre-determined gating scheme.

In some embodiments, the step of obtaining the maximum delay time interval for the TC of the respective identified TSN stream comprises determining a TC of the respective identified TSN stream and obtaining the maximum delay time interval for the determined TC, the maximum delay time interval being a pre-determined value associated to the respective TC.

In some embodiments, the step of assigning to the respective identified TSN stream, the delay for transmission per TC and per port pair from the ingress port to the egress port of the DS-TT or the NW-TT comprises obtaining each frame of the respective identified TSN stream and the TSN stream information. The method comprises assigning to each frame of the respective identified TSN stream, said delay corresponding to the obtained maximum delay time interval of the TC to which the identified TSN stream belongs.

In some embodiments, the step of assigning to the respective identified TSN stream, the delay for transmission per TC and port pair from the ingress port to the egress port of the DS-TT or the NW-TT comprises receiving one or more TSN streams at the ingress port implementing the first pre-determined gating scheme. The method comprises determining the TC of the respective TSN stream. The method comprises storing the respective TSN stream in a pre-sorting buffer at the egress port until a next pre-determined opening time interval of a gate at the egress port starts. The method comprises arranging, at the egress port implementing a second pre-determined gating scheme, the respective TSN stream to be transmitted, from the egress port, based on a mapping of the first pre-determined gating scheme within the second pre-determined gating scheme by adding the maximum delay time interval to the gating information of the first pre-determined gating scheme. The method comprises releasing frames of the respective TSN stream from the pre-sorting buffer to the egress port for transmission based on said arrangement.

In some embodiments, the step of arranging, at the egress port implementing the second pre-determined gating scheme, the respective TSN stream to be transmitted, from the egress port comprises obtaining the gating information of the first pre-determined gating scheme implemented by the ingress port. The method comprises adding the maximum delay time interval to the gating information of the first pre-determined gating scheme. The method comprises mapping the first pre-determined gating scheme within the second pre-determined gating scheme implemented by the egress port in accordance with the maximum delay time interval added to the gating information of the first pre-determined gating scheme. The method comprises delaying transmission of the respective TSN stream, at the pre-sorting buffer, until a gate at the egress port opens.

According to a second aspect of the present disclosure, a device side Time-Sensitive Networking, TSN, translator, DS-TT, associated with one or more User Equipments, UEs, connected to a network node in a wireless communication network, or a network side TSN translator, NW-TT, associated with a User Plane Function, UPF, of a core network connected to the network node in the wireless communication network is provided. The wireless communication network operates as a virtual TSN bridge of a TSN system. The DS-TT or the NW-TT is being configured for identifying one or more TSN streams being received at an ingress port of the DS-TT or the NW-TT, each of the one or more TSN streams belonging to a Traffic Class, TC. The DS-TT or the NW-TT is configured for obtaining a maximum delay time interval within the wireless communication network for the TC of the respective identified TSN stream. The DS-TT or the NW-TT is configured for assigning to the respective identified TSN stream, a delay for transmission per TC and port pair from the ingress port to an egress port of the DS-TT or the NW-TT, said delay corresponding to the obtained maximum delay time interval of the TC to which the identified TSN stream belongs.

According to a third aspect of the present disclosure, there is provided a computer program product comprising a non-transitory computer readable medium, having thereon a computer program comprising program instructions. The computer program is loadable into a data processing unit and configured to cause execution of the method according to the first aspect when the computer program is run by the data processing unit.

In some embodiments, any of the above aspects may additionally have features identical with or corresponding to any of the various features as explained above for any of the other aspects.

An advantage of some embodiments is that alternative and/or improved approaches are provided for performing transmission of the TSN communication by assigning the delay to the TSN stream for transmission per TC per port pair from the ingress port to the egress port of the DS-TT or the NW-TT. The delay corresponds to the maximum delay interval of the TC to which the identified TSN stream belongs. As a result, the TSN communication may be transmitted with low packet delay variation, PDV.

An advantage of some embodiments is that the delay to the TSN stream may be assigned without a need to standardize at both ingress and egress ports of the DS-TT or the NW-TT (i.e., devices/equipment from different vendors).

An advantage of some embodiments is that due to assigning of delay to the TSN stream, the TSN stream may spend maximum packet delay time, PD_max (when the wireless communication network reports minimum packet delay time, PD_min=PD_max to a Centralized Network Controller, CNC) between the ingress and egress ports before transmitting to a next TSN node. As a result, the PDV is zero, since there is no variation in packet delay.

Other advantages may be readily apparent to one having skill in the art. Certain embodiments may have none, some, or all of the recited advantages.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 discloses an example of a Time Sensitive Networking, TSN, system integrated to a wireless communication network according to some examples;

FIG. 2 discloses an example of a TSN system integrated to a wireless communication network, which acts as a virtual TSN bridge according to some examples;

FIG. 3 discloses an example of a wireless communication network according to some examples;

FIGS. 4A, 4B, and 4C disclose an example architecture of a TSN system integrated to a wireless communication network according to some examples;

FIG. 5 is a flowchart illustrating example method steps according to some examples;

FIGS. 6A and 6B disclose an example illustration of transmitting TSN communication through a wireless communication network by assigning a delay to each frame of the TSN stream;

FIG. 7 disclose an example illustration of transmitting TSN communication through a wireless communication network by mapping a first pre-determined gating scheme implemented by an ingress port within a second pre-determined gating scheme implemented by an egress port;

FIG. 8 is a schematic block diagram illustrating an example apparatus according to some embodiments; and

FIG. 9 discloses an example computing environment according to some examples.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Network node: As used herein, a network node (also be referred to as radio access node, radio network node, or the like) is any node in a Radio Access Network, RAN, of a wireless communication network that operates to wirelessly transmit and/or receive signals. Some examples of the network node include, but are not limited to, a base station (for example a New Radio, NR, base station, gNB, in a Third Generation Partnership Project, 3GPP, Fifth Generation, 5G, NR network or an enhanced or evolved Node B, eNB, in a 3GPP Long Term Evolution, LTE, network), a high-power or macro base station, a low-power base station (for example, a micro base station, a pico base station, a home eNB, or the like), a relay node, and so on.

Core network node: As used herein, a core network node is any type of node in a core network that implements a core network function. Some examples of the core network node include, for example, a Mobility Management Entity, MME, a Packet Data Network Gateway, P-GW, a Service Capability Exposure Function, SCEF, a Home Subscriber Server, HSS, or the like. Some other examples of the core network node include a node implementing an Access and Mobility Function, AMF, a User Plane Function, UPF, a Session Management Function, SMF, an Authentication Server Function, AUSF, a Network Slice Selection Function, NSSF, a Network Exposure Function, NEF, a Network Repository Function, NRF, a Policy Control Function, PCF, a Unified Data Management, UDM, and so on.

User Equipment, UE: As used herein, a UE (also be referred to as wireless device) is any type of device that has access to (i.e., is served by) a wireless communication network by wirelessly transmitting and/or receiving signals to a network node(s). Some examples of the UE are a target device, a device to device, D2D, UE, a machine type UE, a UE capable of machine to machine, M2M, communication, personal digital assistant, PDA, tablet, mobile terminals, smart phone, laptop embedded equipped, LEE, laptop mounted equipment, LME, universal serial bus, USB, dongles, UE category M2, ProSe UE, and so on.

Note that the description given herein focuses on a 3GPP wireless communication network and, as such, 3GPP terminology or terminology similar to 3GPP terminology is oftentimes used. However, the concepts disclosed herein are not limited to a 3GPP system.

Embodiments of the present disclosure will be described and exemplified more fully hereinafter with reference to the accompanying drawings. The solutions disclosed herein can, however, be realized in many different forms and should not be construed as being limited to the examples set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

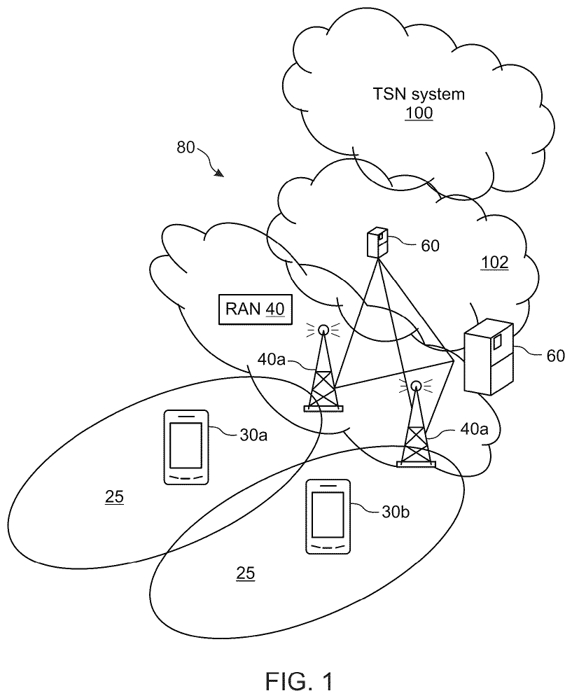

FIG. 1 discloses an example of a Time Sensitive Networking, TSN, system, 100 integrated to a wireless communication network 80. As depicted in FIG. 1, the TSN system 100 may be integrated to the wireless communication network 80 to provide converged communication on a same network infrastructure for a wide range of services, for example, time sensitive applications that require deterministic, reliable and low latency communications.

The TSN system (also be referred to as TSN network) 100 may be based on the Institute of Electrical and Electronics Engineers, IEEE 802.3 Ethernet standard. The TSN system may provide deterministic services through IEEE 802.3 networks, for example, time synchronization, guaranteed low latency transmissions and high reliability.

The wireless communication network (also be referred to wireless communication system, cellular communication network/system, or the like) may be a wireless network, for example, a Fifth Generation, 5GS, network, a Long Term Evolution, LTE, network, an Evolved Universal Terrestrial Radio Access Network, E-UTRAN, a Wideband Code Division Multiple Access, WCDMA, network, a Global System for Mobile communications, GSM, network, a Worldwide Interoperability for Microwave Access, WiMAX, or any other future generation network.

The wireless communication network 80 comprises a Radio Access Network, RAN, 40 and a core network, CN, 60. The wireless communication network 80 may use a number of different Radio Access Technologies, RATs, such as LTE, LTE-Advanced, 5G, WCDMA, GSM/Enhanced Data rate for GSM Evolution, EDGE, WiMAX, Ultra Mobile Broadband, WMB, or the like.

The RAN 40 comprises one or more network nodes 40a, each providing radio coverage over one or more geographical areas, such as cells 25 supporting the one or more RATs. In some examples, the network node 40a may be a radio access node such as a radio network controller, an access point such as a Wireless Local Area Network, WLAN, access point or an Access Point Station, AP STA, an access controller, a base station, a base transceiver station, an Access Point base station, a base station router, a transmission arrangement of a radio base station, a standalone access point, or any other unit of the RAN capable of serving one or more User Equipments, UEs 30a, 30b, in the cell/service area. Examples of the base station may include, a gNodeB, gNB, an evolved Node B, eNB, and so on.

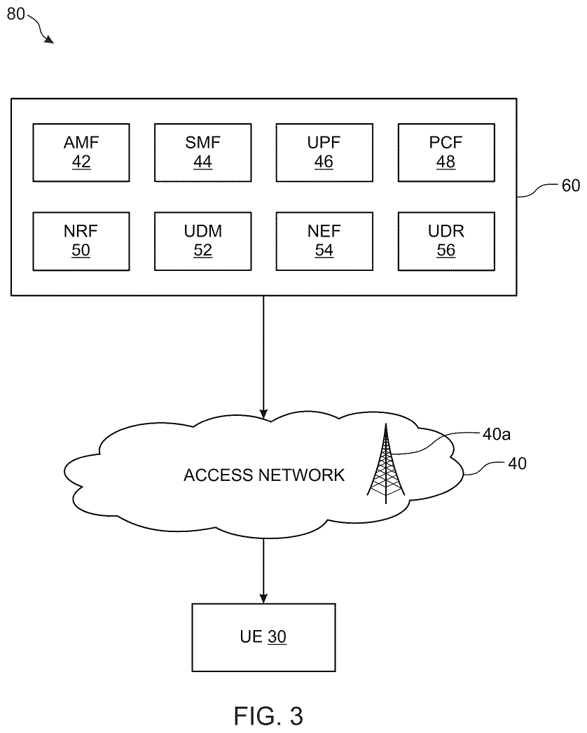

The CN 60 comprises a core network node. The core network node may be configured to communicate with the network node 40a via an interface, for example, an S1 interface. Examples of the core network node may include, a Mobile Switching Centre, MSC, a Mobility Management Entity, MME, an Operation and Management, O&M, node, an Operation, Administration and Maintenance, OAM, node, an Operations Support Systems, OSS, node, a Self-Organizing Network, SON, node, a Packet Data Network Gateway, P-GW, a Service Capability Exposure Function, SCEF, a Home Subscriber Server, HSS, or the like. The core network node may further be a distributed node comprised in a cloud 102. The core network node may further include a node implementing network functions of the CN 60 such as but are not limited to, an Access and Mobility Function, AMF, a User Plane Function, UPF, a Session Management Function, SMF, an Authentication Server Function, AUSF, a Network Slice Selection Function, NSSF, a Network Exposure Function, NEF, a Network Repository Function, NRF, a Policy Control Function, PCF, a Unified Data Management, UDM, and so on. The network functions of the CN 60 are described in detail in conjunction with FIG. 3.

In the wireless communication network 80, the one or more UEs 30a and 30b (collectively referred to as UE 30) may communicate with the CN 60 via the network nodes 40a of the RAN 40. Examples of the UE 30 may include, a wireless device, a mobile station, a non-access point, non-AP, station, STA, a wireless terminal, or the like. It should be understood by those skilled in the art that “wireless device” is a non-limiting term, which means any terminal, a wireless communication terminal, a User Equipment, a Mobile Type Communication, MTC, device, a Device to Device, D2D, terminal, or a node for example, a smart phone, a laptop, a mobile phone, a sensor, a relay, a mobile tablet, or even a base station communicating within the cell.

The UE 30 may be located in the cell 25 of the network node 40a, which is referred to as a serving cell and the cell of other network nodes may be referred to as neighbouring cells for the UE 30. Although the network node 40a, in FIG. 1, is only providing a serving cell 25, the network node 40a may further provide one or more neighbouring cells to the serving cell 25.

The UE 30 (also be referred to as first end station) may be connected to one or more end stations such as one or more second end stations. The second end station may include, but are not limited to, robots, a factory floor, or the like.

The wireless communication network 80 may according to some embodiments herein communicate with one or more nodes in the TSN system 100. The TSN system 100 may be connected to one or more end stations, such as, the second end stations.

According to some embodiments herein, with the integration of the TSN system 100, the wireless communication network 80 operates as a virtual TSN node (also be referred to as virtual TSN bridge, TSN virtual bridge, virtual wireless bridge, or the like).

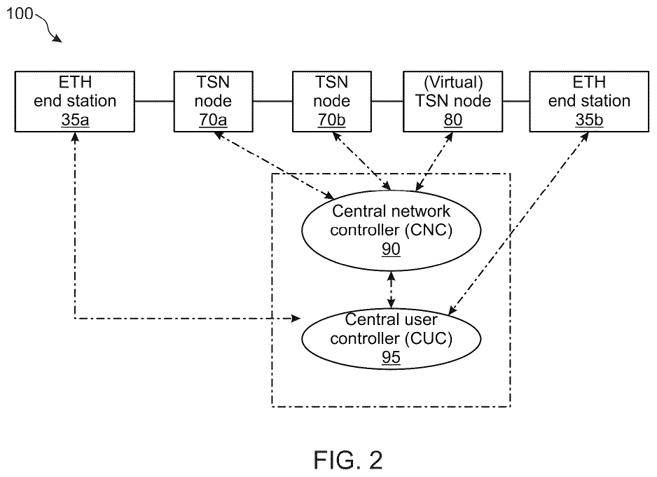

FIG. 2 discloses an example of the TSN system 100 integrated to the wireless communication network 80, wherein the wireless communication network 80 operates as the virtual TSN node. The TSN system 100 comprises one or more TSN nodes. For simplicity, the TSN system 100 comprising TSN nodes 70a and 70b is depicted in FIG. 2. The TSN nodes 70a and 70b may be wired TSN nodes (also be referred to as wired nodes, wired TSN bridges, or the like). With the integration of the TSN system 100 to the wireless communication network 80, the TSN system 100 may comprise the virtual TSN node 80. The virtual TSN node 80 referred herein may be the wireless communication network 80 or the virtual TSN node 80 may be a node implemented by the wireless communication network 80.

The TSN nodes 70a and 70b, and the virtual TSN node 80 may be connected to one or more end stations, for example, second end stations, which suppose to exchange time sensitive communication. The time sensitive communication may comprise TSN streams or TSN packets, or TSN flows to be exchanged between the end stations. As depicted in FIG. 2, the TSN node 70a may be connected to an end station 35a and the virtual TSN node 80 may be connected to an end station 35b. Examples of the end stations 35a and 35b may include, but are not limited to, robots, a factory floor, or the like. The end stations 35a and 35b may be connected to the UEs associated with the virtual TSN node 80 through the TSN nodes 70a/70b (not shown).

In some examples, the TSN nodes 70a and 70b, the virtual TSN node 80, and the end stations 35a and 35b may be configured in a static configuration setup or a centralized network configuration setup. In the static configuration setup, the TSN nodes 70a and 70b, the virtual TSN node 80, and the end stations 35a and 35b may be configured during network setup. In the centralized network configuration setup, a Centralized Network Controller, CNC, 90 (also be referred to as centralized network configuration, TSN controller, or the like) may configure the TSN nodes 70a and 70b, and the virtual TSN node 80 for TSN streams (data packets exchanged between the end stations through the TSN nodes 70a and 70b and the virtual TSN node 80). The CNC 90 may be adapted for configuring network resource reservations for the TSN nodes 70a and 70b, and the virtual TSN node 80. The CNC 90 may also be adapted for coordinating any changes to the configured network resource reservations with any new reservations. The network resource reservations may be made or requested by the end stations 35a and 35b. In the fully centralized network configuration setup, where both network and user configuration are centralized, the CNC may receive requirements of data flows from a Centralized User Controller, CUC, 95 (also be referred to as centralized user configuration) and then compute a route, and a time schedule required for end-to-end, E2E, transmission for each TSN stream. The CNC may also configure the TSN nodes 70a and 70b and the virtual TSN node 80 in accordance with the computed route and time schedule.

In some embodiments, the wireless communication network acting as the virtual TSN node 80 may obtain, from a controller of the TSN system (not shown) or the CNC 90, one or more TSN Quality of Service, QoS, parameters and information related to a traffic pattern for the virtual TSN node 80. The TSN QoS parameters may be mapped to QoS policy(ies) and/or rules in the wireless communication network and applied in the wireless communication network in order to satisfy TSN QoS requirements for the virtual TSN node. In addition, at least some of the information related to the traffic pattern for the virtual TSN node may be provided to an edge node to achieve the desired traffic pattern. In some examples, the edge node may be the UPF of the CN for uplink direction or the UE for downlink direction.

In some other embodiments, the wireless communication system operating as the virtual TSN node 80 may obtain, from the controller of the TSN system or the CNC 90, information related to the traffic pattern for the preceding TSN node 70b (the TSN node that precedes the virtual TSN node 80 in a direction of TSN traffic flow). At least some of the information related to the traffic pattern for the preceding TSN node 70b may be provided to the one or more network nodes of the wireless communication system for radio optimization. Components of the wireless communication network operating as the virtual TSN node 80 is described in detail in conjunction with FIG. 3.

FIG. 3 discloses the wireless communication network 80 operating as the virtual TSN node, while integrated to the TSN system. As depicted in FIG. 3, the wireless communication network 80 comprises the RAN 40, the CN 60, and the UE 30. The RAN 40 includes the network node 40a.

The network node 40a may be directly connected to the UE 30. The network node 40a may include a group of a plurality of base stations including a base station, and the plurality of base stations may perform communication via an interface. The base station may have a structure having a central unit, CU, and a distributed unit, DU, separated from each other. In this case, one CU may control a plurality of DUs. The base station may be referred to as an access point, AP, a next-generation node i.e., a gNB, a 5th generation node, a wireless point, or a transmission/reception point, TRP, or the like. The UE 30 accesses the RAN 40 and communicates with the network node 40a through a wireless channel. The UE 30 may be a user equipment, UE, a mobile station, a subscriber station, a remote terminal, a wireless terminal or the like.

The CN 60, which is the network that manages or controls the RAN 40 and processes data and control signals for the UE 30, transmitted and received via the RAN 40. The CN 60 may perform various functions including control of a user plane and a control plane, processing of mobility, management of subscriber information, charging, and interworking with other types of systems such as, LTE, system.

To perform the various functions described above, the CN 60 may include a plurality of functionally separated entities (i.e., core network nodes) having different network functions. For example, the network functions may include an AMF 42, a SMF 44, a UPF 46, a PCF 48, a network repository function, NRF 50, a UDM 52, a NEF 54, and a unified data repository UDR 55. Although, not shown in FIG. 3, the CN 60 may interwork with a TSN Application Function, AF, the CNC and the TSN system. In some examples, the CN 60 may be referred as a 5th generation, 5G, core, 5GC, which is a core network of a 5G system.

The UE 30 connected to the RAN 40 may accesses the AMF 42, which performs a mobility management function of the CN 60. The AMF 42 is a function or a device that is responsible for both access to the RAN 40 and the mobility management of the UE 30. The SMF 44 is a network function that manages a session. The AMF 42 may be connected to the SMF 44, and the AMF 42 may route session-related messages of the UE 30 to the SMF 44. The SMF 44 may be connected to the UPF 46 to allocate a user plane resource to be provided to the UE 30 and establish a tunnel for transmitting data between the network node 40a and the UPF 46. The SMF 44, as a main entity managing a Protocol Data Unit, PDU session, may be responsible for QoS setting/update for QoS flows in the PDU session. The PCF 48 may control information associated with a policy and charging of a session used by the UE 30. The NRF 50 may be connected to all the network functions. Each network function is registered with the NRF 50 when starting to run in the operator network, so as to inform the NRF 50 that the network function is running in the wireless communication network 80. The UDM 52, as a network function may perform a role similar to a home subscriber server, HSS, of a 4G network, and store subscription information of the UE 30 or context information used by the UE 30 in the network.

The NEF 54 may serve to connect a third party server to the network function in the wireless communication network 80. In addition, the NEF 54 may serve to provide data to the UDR 56 and to update or obtain data. The UDR 56 may serve to store subscription information of the UE 30, store policy information, store data exposed to the outside, or store information necessary for a third-party application. Further, the UDR 56 may also serve to provide stored data to other network functions.

The UDM 52, PCF 48, SMF 44, AMF 42, NRF 50, NEF 54, and UDR 56 may be connected to a service-based interface. Services or application programing interfaces, APIs, provided by these network functions are used by other network functions and thus may exchange control messages with each other. For example, when the AMF 42 delivers a session-related message to the SMF 44, a service or API called Nsmf_PDUSession_CreateSMContext may be used.

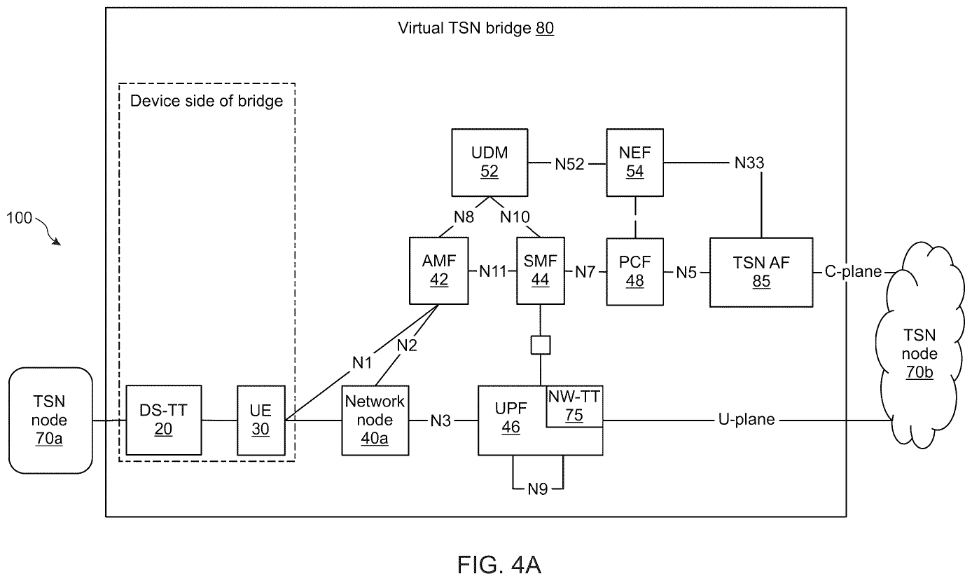

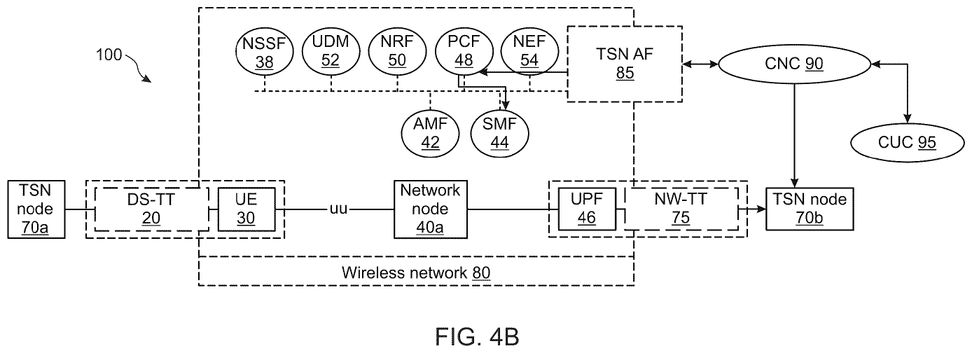

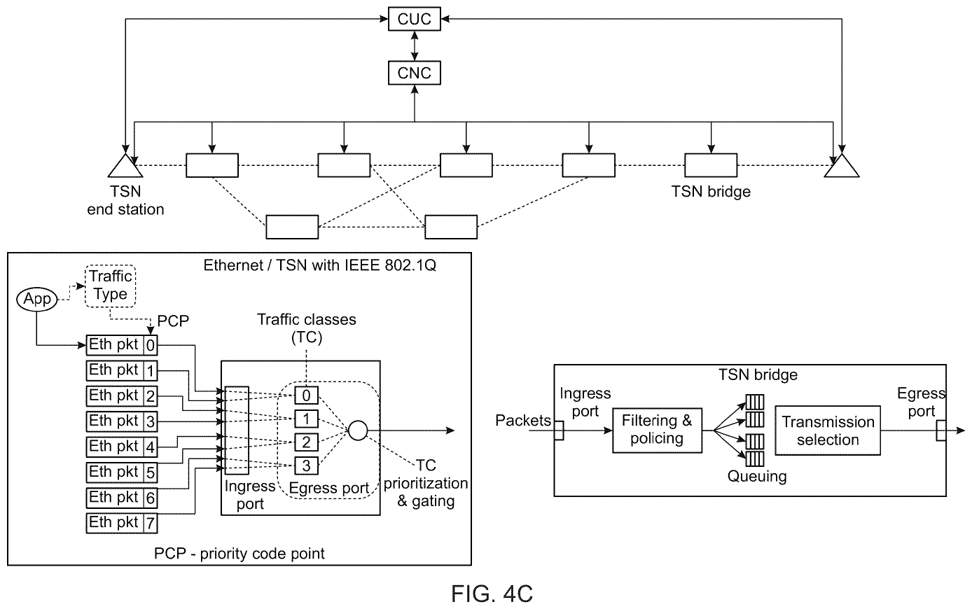

FIGS. 4A, 4B, and 4C disclose an example architecture of the TSN system 100 integrated to the wireless communication network 80 in which embodiments of the present disclosure may be implemented. For a seamless integration between the wireless communication network 80 and the TSN system 100, the wireless communication network 80 and the TSN system 100 may interoperate in a transparent manner to minimize impact on other TSN entities.

With the integration of the TSN system 100 to the wireless communication network 80, the TSN system 100 comprises the one or more TSN nodes/wired TSN bridges 70a and 70b, and the virtual TSN node 80. The TSN nodes 70a and 70b and the virtual TSN node 80 are described in detail in conjunction with FIG. 2.

The virtual TSN node/wireless communication network 80 comprises the RAN and the CN. The RAN comprises the network node 40a. The CN comprises network functions such as, the AMF 42, the SMF 44, the PCF 48, the NEF 54, the UDM 52, the UPF 46, a NSSF 38, or the like. All these network functions of the CN are described in detail in conjunction with FIG. 3.

In some examples, the virtual TSN node/wireless communication network 80 may define several gateways, which enable the virtual TSN node 80 to communicate with the TSN system 100 and the CNC 90. The gateways may include the TSN AF 85, a device side TSN translator, DS-TT, 20, on the UE 30, and a network side TSN translator, NW-TT, 75 on the UPF 46 of the CN. TSN ingress ports and egress ports may be provided via the DS-TT 20 on the UE 30 and via the NW-TT 75 on the CN.

In some examples, the DS-TT 20 and the NW-TT 75 may support hold and forward functionality of purpose of de-jittering, and per-stream filtering and policing as defined in clause 8.6.5.1 of IEEE std 802.1Q. The DS-TT 20 may optionally support link layer connectivity discovery and reporting as defined in IEEE std 802.1AN for discovery of the end stations attached to the DS-TT 20. The NW-TT 75 may support link layer connectivity discover and reporting as defined in IEEE std 802.1AB for discovery of the end stations attached to the NW-TT 75. If the DS-TT 20 does not support the link layer connectivity discovery and reporting, the NW-TT 75 may perform the link layer connectivity discovery and reporting as defined in IEEE std 802.1AB for discovery of the end stations attached to the DS-TT 20 on behalf of the DS-TT 20.

The DS-TT 20 or the NW-TT 75 may comprise an ingress port and an egress port. The ingress port may be a port at which the TSN streams may be received. The egress port may be a port at which the TSN streams may be forwarded/transmitted to the next node in the TSN system. Handling of end-to-end traffic/TSN streams at the ingress port and the egress port of the DS-TT 20 or the NW-TT 75 is depicted in FIG. 4C. As depicted in FIG. 4C, the TSN streams may be provided with a priority specified as a Priority Code Point, PCP, in an Ethernet header. Each TSN stream received at the ingress port may be mapped to a Traffic Class, TC, according to the PCP. The TSN traffic shaping policy may be applied to the TSN streams received at the ingress port, which comprises filtering and policing of the TSN streams, and separation of the TSN streams into different queues according to the TC. Thereafter, the TSN streams may be forwarded to the next node in the TSN system from the egress port using a transmission selection policy. The transmission selection policy may include selecting the queues and transmitting the TSN streams from the different selected queues.

In some examples, the ingress port and the egress port may implement pre-defined gating schemes. In some examples, the ingress port and the egress port may implement the same pre-defined gating schemes. In some examples, the ingress port and the egress port may implement the different pre-defined gating schemes. Examples of the pre-defined gating schemes may include a Per-Stream Filtering and Policing, PSFP, and an 802.1Qbv. The PSFP may be a mechanism that policies the ingress ports and defined per TSN stream. The PSFP defines a time window by which arriving packets of the TSN system are allowed to enter, while any packets outside of the time window may be dropped. The 802.1Qbv may define similar time windows for the egress port and on a per TC basis (i.e., for multiple TSN streams being belonging to the same traffic class). The 802.1Qbv defines the time window to store the packets of the TSN streams in a Qbv queue (of the egress port for the TC) and transmit out to the next node in the TSN system. The PSFP and the 802.1Qbv are based on gates that open during the allowed time window and let pass corresponding packets of the TSN streams either to be transmitted out of the egress port or being received at the ingress port. The gate closes at the end of the time window. When the gate is closed, the packets of the TSN streams are dropped, while the Qbv queues the packets until the packets may be transmitted through the open gate again. The TSN streams may be periodic, which implies periodic gating.

The TSN AF 85 may be configured to connect the CNC 90, the CUC 95 entities and a control plane, C-plane.

In some examples, the TSN AF 85 may be associated with the CN. In some examples, the TSN AF 85 may be a third party entity outside an operator network or an entity inside the operator network. For example, the TSN AF 85 may be an entity within the CN, which is inside the operator network, since the CN corresponds to an essential function for supporting TSN. The TSN AF 85 may derive information about a TSN stream from information provided by the CNC 90 in the form of bridge management information, and possibly using other configuration data. The TSN AF 85 may determine QoS parameters including: a priority, a Maximum Burst Size, a delay and a Maximum Bitrate, and may provide these parameters to the PCF 48.

In some examples, the CNC 90 may be configured to configure and operate the TSN nodes 70a and 70b of the TSN system 100 and the virtual TSN node 80. The CNC 90 may configure the TSN nodes 70a and 70b of the TSN system 100 and the virtual TSN node 80 in the fully centralized TSN configuration setup. In some examples, the fully centralized TSN configuration may include the following steps:
traffic characteristics and service requirements may be provided for individual TSN streams from the CUC to the CNC;
a network topology, characteristics, and capabilities of the TSN nodes 70a and 70b and the virtual TSN bridge may be collected the by the CNC;
transmission paths for the TSN streams may be determined by the CNC based on service requirements, network capabilities, and traffic distribution in the TSN system 100; and
the TSN nodes 70a and 70b, the virtual TSN bridge 80, and potentially the TSN end stations on the transmission paths may be configured with a TSN traffic shaping policy to be applied for the TSN stream.

The CNC 90 operates the virtual TSN node 80 by considering the virtual TSN node as the TSN node. However, there are some substantial differences between the virtual TSN node 80 and the TSN node 70a/70b. One of the differences is that PDV of the 5G network remains considerable higher, for example, 1-2 orders of magnitude compared to the wired TSN nodes where latencies can be controlled at a level of 10's microsecond. Thus, a key challenge in achieving deterministic transmission latency in the integrated TSN-5G network is higher PDV of the 5G network. Thus, it is desirable to limit PDV for achieving deterministic transmission latency related to time sensitive communication.

Therefore, according to some embodiments of the present disclosure, the DS-TT 20 on the UE 30 or the NW-TT 75 of the UPF 46 of the CN 60 connected to the network node 40a in the wireless communication network 80, implements a method for handling transmission of TSN information through the wireless communication network 80 to reduce/decrease PDV.

The DS-TT 20 or the NW-TT 75 identifies one or more TSN streams being received at the ingress port of the DS-TT 20, or the NW-TT 75. Each of the one or more TSN streams belongs to a TC. In some examples, the one or more TSN streams may belong to the same TC. In some examples, the one or more TSN streams may belong to different TC. Upon identifying the one or more TSN streams, the DS-TT 20 or the NW-TT 75 obtains a maximum delay time interval within the wireless communication network 80 for the TC of the respective identified TSN stream. The DS-TT 20 or the NW-TT 75 assigns to the respective identified TSN stream, a delay for transmission per TC and port pair from the ingress port to the egress port of the DS-TT 20 or the NW-TT 75. The delay corresponds to the maximum delay time interval of the TC to which the identified TSN stream belongs. The assigned delay corresponding to the maximum delay time interval of the TC to which the identified TSN stream belongs relates to delay of the TSN stream within the wireless communication network. Thus, delaying and transmitting the TSN streams (i.e., holding and forwarding) based on the associated TC and port pair may reduce/decrease PDV associated with transmission of TSN information through the wireless communication network 80.

Various examples for transmission of the TSN communication through the wireless communication network are explained in conjunction with figures in the later parts of the description.

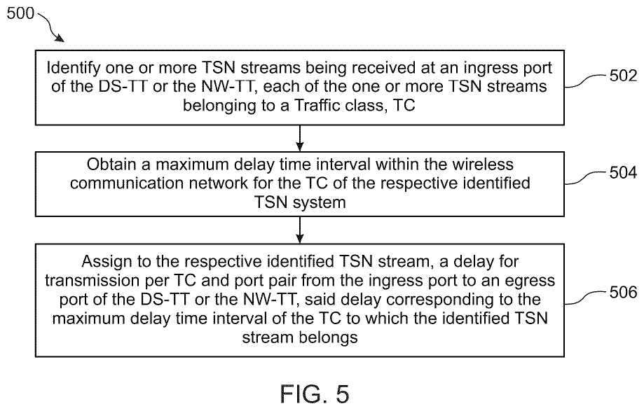

FIG. 5 is a flowchart illustrating example method steps of a method 500 performed by the DS-TT associated with the UE connected to the network node in the wireless communication network or by the NW-TT associated with the UPF of the CN connected to the network node in the wireless communication network. The wireless communication network operates as the virtual TSN bridge of the wireless communication network. The DS-TT or the NW-TT may comprise an ingress port and an egress port for receiving TSN streams from a preceding node and forwarding the TSN streams to a next node in the TSN system, respectively. In some examples, the preceding node and the next node in the TSN system may be TSN bridges connected to the end stations. Also, the ingress port and the egress port may implement pre-determined gating schemes such as, PSFP, 802.1Qbv, and so on. Handling of the TSN streams at the ingress port and the egress port and the pre-determined gating schemes are described in detail in conjunction with FIG. 4C.

At step 502, the method 500 comprises identifying one or more TSN streams being received at the ingress port of the DS-TT or the NW-TT. Each of the one or more TSN streams belongs to the TC. It should be noted that the one or more TSN streams may belong to the same TC or the different TC. The TC of the TSN stream may be identified from an Ethernet header (referred to as a header) of the TSN stream. In some examples, for each TSN stream, the ingress port and the egress port may be determined using, for example, static filtering entries, local configuration TS 23.501, clause 5.28.2, or the like. The TSN streams may be associated with information such as burst arrival time, a TC of the identified respective TSN stream, a periodicity of each identified TSN stream, or the like

In some embodiments, the method 500 also comprise obtaining TSN stream information of the identified one or more TSN streams. The TSN information comprises gating information of a first pre-determined gating scheme and gating information of a second pre-determined gating scheme. In an example herein, the first pre-determined gating scheme may be PSFP and the second pre-determined gating scheme may be 802.1Qbv. In some examples, the gating information of the first/second pre-determined gating scheme may comprise an opening time interval and a closing time interval of a gate at the ingress port and/or the egress port supporting the first/second pre-determined gating scheme (i.e. a time window determined for opening and closing of the gate at the ingress port or the egress port).

After identifying the one or more TSN streams, at step 504, the method 500 comprises obtaining a maximum delay time interval within the wireless communication network for the TC of the respective identified TSN stream. In some embodiments, the step 504 of obtaining the maximum delay time interval for the TC of the respective identified TSN stream may comprise determining a TC of the respective identified TSN stream, and obtaining the maximum delay time interval for the determined TC. The maximum delay time interval may be a pre-determined value associated to the respective TC.

Upon obtaining the maximum delay time interval for the TC, at step 506, the method 500 comprises assigning to the respective identified TSN stream, the delay for transmission per TC and port pair from the ingress port to the egress port of the DS-TT or the NW-TT. The delay corresponds to the obtained maximum delay time interval of the TC to which the identified TSN stream belongs. The assigned delay corresponding to the obtained maximum delay time interval of the TC to which the identified TSN stream belongs may relate to delay of the TSN stream within the wireless communication network.

In some embodiments, the step of assigning to the respective identified TSN stream, the delay for transmission per TC and port pair from the ingress port to the egress port of the DS-TT or the NW-TT may comprise obtaining each frame of the respective identified TSN stream and the TSN stream information. The method may comprise assigning to each frame of the identified TSN stream, the delay corresponding to the obtained maximum delay time interval of the TC to which the identified TSN stream belongs. Assigning the delay to each frame of the identified TSN stream may refer to adding the maximum delay time interval to the gating information of the pre-determined gating scheme (for example, the PSFP) supported by the ingress port. Thus, assigning the delay to each frame may enable the frame of the TSN stream to wait until the gate at the ingress port mapped with the gate at the egress port is open to transmit. Such a transmission may reduce/decrease PDV associated with transmission of TSN information through the wireless communication network.

In some embodiments, the step of assigning to the respective identified TSN stream, the delay for transmission per TC and port pair from the ingress port to the egress port of the DS-TT or the NW-TT may comprise receiving the one or more TSN streams at the ingress port implementing the first pre-determined gating scheme and determining the TC of the respective TSN stream. The method may comprise storing the respective TSN stream in a pre-sorting buffer at the egress port until a next pre-determined opening time interval of the gate at the egress port starts (i.e., the next opening of the gate at the egress port). In some examples, the buffer may be per stream and pre-sorting buffer maintained at the egress port. Upon storing the TSN stream in the pre-sorting buffer, the method may comprise arranging, at the egress port implementing the second pre-determined gating scheme, the respective TSN stream to be transmitted, from the egress port, based on mapping of the first pre-determined gating scheme within the second pre-determined gating scheme by adding the maximum delay time interval to the gating information of the first pre-determined gating scheme. The method may comprise releasing frames of the respective TSN stream from the pre-sorting buffer to the egress port for transmission based on said arrangement.

In some embodiments, the step of arranging, at the egress port implementing the second pre-determined gating scheme, the respective TSN stream to be transmitted, from the egress port may comprise obtaining the gating information of the first pre-determined gating scheme implemented by the ingress port. The method may comprise adding the maximum delay time interval to the gating information of the first pre-determined gating scheme. The method may comprise mapping the first pre-determined gating scheme within the second pre-determined gating scheme implemented by the egress port in accordance with the maximum delay time interval added to the gating information of the first pre-determined gating scheme. Thus, the first and second pre-determined gating schemes may be mapped by adding the maximum time interval delay to the gating information of the first pre-determined gating scheme. After mapping the first and second pre-determined gating schemes, the method may comprise delaying transmission of the respective TSN stream, at the pre-sorting buffer, until a gate at the egress port opens. Such a method of delaying and transmitting the TSN streams (i.e., holding and forwarding) based on the associated TC may reduce/decrease PDV associated with transmission of TSN information through the wireless communication network.

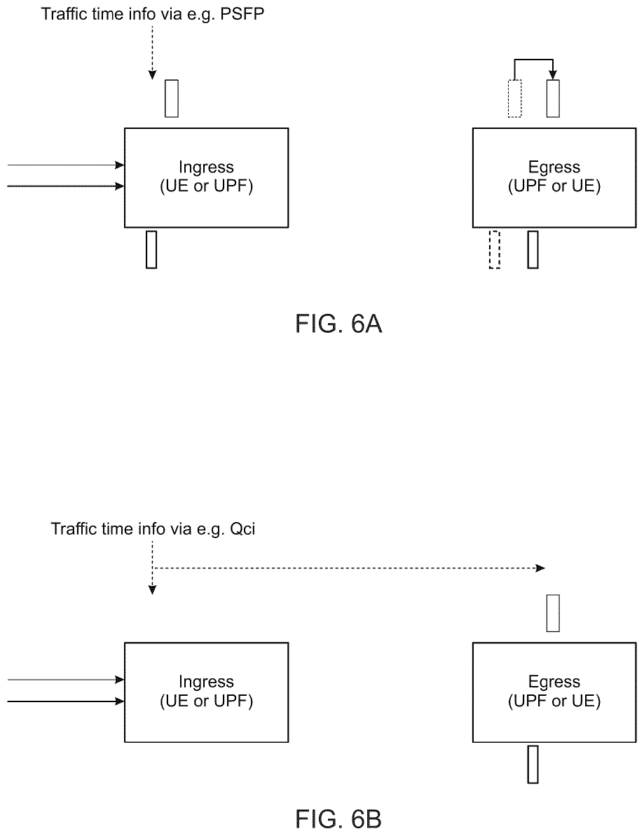

FIGS. 6A and 6B disclose an example illustration of transmitting the TSN communication through the wireless communication network by assigning a delay to each frame of the TSN stream. Embodiments herein consider the wireless communication network as a 5G network, but it is obvious to the person skilled in the art that any other wireless communication network can be considered.

As depicted in FIGS. 6A and 6B, the DS-TT on the UE connected to the network node of the 5G network or the NW-TT on the UPF of the CN connected to the network node of the 5G network comprises an ingress port and an egress port for reception and transmission of the TSN streams of the TSN communication, respectively. The ingress port and the egress port may implement same or different pre-determined gating schemes. Examples of the pre-determined gating schemes may include PSFP, 802.1Qbv, and so on (disclosed in detail in conjunction with FIG. 4C). The ingress port and the egress port may have gates and queues for controlling reception and transmission of the TSN streams. The ingress port and the egress port implementing the PSFP are depicted in FIG. 6A, and 6B.

For each TSN stream of the TSN communication, the ingress port and the egress port may be determined using, for example, static filtering entries, local configuration TS 23.501, clause 5.28.2, or the like. Similarly, the ingress port and the egress port of the DS-TT or the NW-TT may obtain (i.e., pre-configured with) the TSN stream information and traffic time information related to each TSN stream. The TSN stream information may comprise gating information of the PSFP (i.e., PSFP gating information. The traffic time information may comprise a burst arrival time (burst arrival), a TC of each TSN stream, a periodicity of each TSN stream, or the like. In some examples, if the ingress port and the egress port of the DS-TT or the NW-TT implement the PSFP, the ingress port and the egress port may obtain the TSN stream information/traffic time information via PSFP information, as depicted in FIG. 6A. Further, worst and best time that a frame of the TSN stream may arrive to the 5G network may be known based on PSFP (time_min, time_max) at the ingress port provided by a size of a gate at the ingress port, wherein time_max may be 5G_delay_max/PD_max, which is the residence time reported by the 5G network to the CNC. That is when the ingress port is implementing the PSFP, the frames arrived at the ingress port may reach the egress port no later than 5G_delay_max/PD_max. In some examples, the ingress port and the egress port may obtain the TSN stream information/traffic time information via Quality of Service, QoS, Class Identifier, Qci, as depicted in FIG. 6B.

For transmission of the TSN communication through the 5G network, the DS-TT or the NW-TT identifies the TSN streams arrived at the ingress port. In an example herein, the TSN streams belonging to the same TC is depicted in FIGS. 6A and 6B. However, it should be noted that it is obvious to the person skilled in the art that embodiments of the present disclosure may be implemented by considering the TSN streams belonging to the different TCs. After identifying the TSN streams arrived at the ingress port, the DS-TT or the NW-TT determines the TC of the each identified TSN stream (from an Ethernet header of the TSN stream or the TSN stream information) and obtains maximum delay time interval within the 5G network for the determined TC. Upon obtaining the maximum delay time interval, the DS-TT or the NW-TT adds a delay for each TSN stream for transmission per TC and port pair from the ingress port to the egress port of the DS-TT or the NW-TT. The delay corresponds to the maximum delay time interval of the TC to which the identified TSN stream belongs. As depicted in FIGS. 6A and 6B, the DS-TT or the NW-TT may assign the delay to each frame of each TSN stream for transmission from the ingress node to the egress node. Each frame may wait until the gate at the ingress port mapped with the gate at the egress port opens. Thus, providing a packet delay correction, PDC, mechanism for correcting PDV associated with transmission of the TSN streams through the wireless communication network.

For example, for transmission of the TSN communication, in accordance with the TSN stream information and/or traffic time information/5G time information shared between the ingress port and the egress port, the following steps are performed:
a gate at the egress port (i.e., an egress gate) may be created, which may be mapped with the gate at the ingress port;
queues at the egress port and the ingress port may be aligned; and
the delay (corresponding to the maximum time maximum delay time interval of the TC to which the identified TSN stream belongs, i.e., PD_max) may be assigned to each frame of each TSN stream identified at the ingress port to be transmitted per TC and per port pair from the ingress port to the egress port

After adding the delay to each frame of the TSN stream for transmission, the egress gate and the corresponding queue (i.e., the queue at the egress port) may be configured per TSN stream to open exactly at a target time window for transmission of each frame of the TSN stream. In some examples, the egress gate and the corresponding queue may be opened and closed at T_i+PD_max, and T_i+PD_max, respectively, wherein T_i represents burst arrival time of the TSN stream. Thus, at the egress port, the frame of the TSN stream may be delayed by (5G_delay_max+PSFP_gate_size)−(Time_at_egress-time_max).

If multiple streams are multiplexed via the same Quality of Service, QoS, flow/Protocol Data Unit, PDU, session, a stream discriminator may be required to match the TSN stream to the correct egress gate. Such a stream discriminator may be transmitted in a packet header/Ethernet header to the receiver (UE or UPF), or is signalled to the receiver by other means.

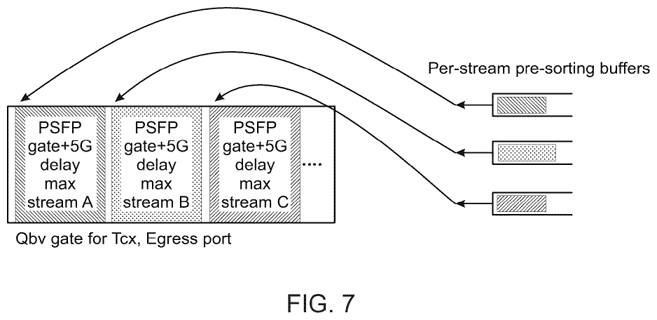

FIG. 7 disclose an example illustration of transmitting the TSN communication through the wireless communication network by mapping the first pre-determined gating scheme implemented by the ingress port with the second pre-determined gating scheme implemented by the egress port. Embodiments herein consider the wireless communication network as a 5G network, but it is obvious to the person skilled in the art that any other wireless communication network can be considered.

The DS-TT on the UE connected to the network node of the 5G network or the NW-TT on the UPF of the CN connected to the network node of the 5G network comprises an ingress port and an egress port for reception and transmission of the TSN streams of the TSN communication, respectively. In an example herein, as depicted in FIG. 7, the ingress port of the DS-TT or the NW-TT implements PSFP (i.e., the first pre-determined gating scheme) and the egress port of the DS-TT or the NW-TT implements 802.1Qbv (i.e., the second pre-determined gating scheme). Hence, gates associated with the ingress port may be referred to as PSFP gates and the gates associated with the egress port may be referred to as Qbv gates. Similarly, queues associated with DS-TT may be referred to as PSFP queues and queues associated with egress port may be referred to as Qbv queues.

For each TSN stream of the TSN communication, the ingress port and the egress port may be determined using, for example, static filtering entries, local configuration TS 23.501, clause 5.28.2, or the like. The ingress port and the egress port may know a TC of each TSN stream, since the TC is carried in the header of each frame of the TSN stream (TC has an egress Qbv queue). Therefore, it is possible to map information related to the PSFP gate for the TSN stream in a per TC Qbv gate. Also, the ingress port and the egress port of the DS-TT or the NW-TT may obtain (i.e., pre-configured with) the TSN stream information and the traffic time information related to each TSN stream. The TSN stream information obtained at the ingress port may comprise gating information of the PSFP (i.e., PSFP gating information (opening and closing time interval of the PSFP gate). The TSN stream information obtained at the egress port may comprise gating information of the 802.1Qbv (i.e., Qbv gating information (opening and closing time interval of the Qbv gate). The traffic time information may comprise a burst arrival time (burst arrival), a TC of each TSN stream, a periodicity of each TSN stream, or the like. Further, the 5G network reports to the CNC (via a control plane) that PD_max=PD_min (i.e., zero PDV) and that there is a single TSN stream in the PSFP gate. Due to such reporting, the frames arrived at the ingress port may reach the egress port no later than PD_max (i.e., 5G_delay_max). Also, the frames of the same TSN stream may be transmitted using same Quality of Service, QoS, flow. As a result, misordering issues in frames of the same TSN stream may be eliminated.

The DS-TT or the NW-TT may identify the one or more TSN streams (for example, a stream A, a stream B, and a stream C) arrived at the ingress port implementing the PSFP. The DS-TT or the NW-TT determines the TC of the streams A, B, and C. In an example herein, as depicted in FIG. 7, it is shown as the streams A, B, and C may belong to the same TC. However, it should be noted that the streams A, B, and C may belong to different TC. The DS-TT or NW-TT stores the streams A, B, and C in per stream pre-sorting buffers, that is three streams are stored in three pre-sorting buffers maintained at the egress port, until a next pre-determined opening time interval of the Qbv gate (i.e., until time of the egress pre-determined next gating time starts).

Upon storing, the DS-TT or the NW-TT arranges, at the egress port implementing the 802.1Qbv, the streams A, B, and C for transmission, based on mapping of the PSFP within the 802.1Qbv by adding the maximum delay time interval to the PSFP gating information. Mapping the PSFP within the 802.1Qbv may refer to mapping of the gate of the PSFP (PSFP gate) with the gate of the 802.1Qbv (i.e., Qbv gate) and delays transmission of the streams A, B, and C, at the pre-sorting buffer, until the Qbv gate opens. Thus, the PSFP defines an order in which the streams A, B, and C to be arranged at the egress port. Further, the streams A, B, and C may be arranged at the egress port (that is filling of the streams A, B, and C into the egress/Qbv queue from the per stream pre-sorting buffers), when the Qbv queue at the egress port is about to open. The DS-TT or the NW-TT releases frames of the respective TSN stream from the pre-sorting buffer to the egress port for transmission based on the above-described arrangement.

Thus, the PSFP gates (for the TSN streams carrying the corresponding TC in the Ethernet header) may be mapped to the Qbv gates of the corresponding TC, by adding the delay (PD_max) to the TSN streams arrived at the ingress port (i.e., adding delay to the PSFP gating information/PSFP gating time values). Mapping may be possible since the ingress and egress ports are time synchronized (which is a requirement to apply for supporting 802.1Qbv). Therefore, the opening and closing times of the PSFP gate with added value of the PD_max/delay may be found and matched within the opening and closing of the Qbv gate. Thus, providing a PDC mechanism to correct/reduce PDV associated with transmission of TSN information through the 5G network/wireless communication network.

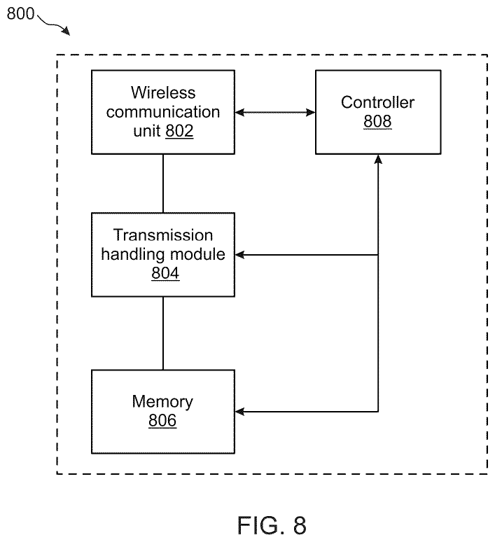

FIG. 8 is an example schematic diagram showing an apparatus 800. The apparatus 800 may e.g. be comprised in the DS-TT associated with the UE connected to the network node in the wireless communication network or the NW-TT associated with the UPF of the CN connected to the network node in the wireless communication network. The apparatus 800 is capable of handling transmission of TSN information through the wireless communication network and may be configured to cause performance of the method 500 for handling transmission of the TSN information through the wireless communication network.

According to at least some embodiments of the present invention, the apparatus 800 in FIG. 8 comprises one or more modules. These modules may e.g. be a wireless communication unit 802, a transmission handling module 804, a memory 806, and a controller 808. The controller 808, may in some embodiments be adapted to control the above mentioned modules.

The wireless communication unit 802, the transmission handling module 804, the memory 806, as well as the controller 808, may be operatively connected to each other.

The controller 808 may be adapted to control the steps as executed by the DS-TT or the NW-TT. For example, the controller 808 may be adapted for handling transmission of the TSN information through the wireless communication network (as described above in conjunction with the method 500 and FIG. 5).

The transmission handling module 804 may be adapted for identifying the one or more TSN streams being received at the ingress port of the DS-TT or the NW-TT, each belonging to a TC, and assigning a delay to the respective identified stream for transmission per TC and port pair from the ingress port to the egress port of the DS-TT or the NW-TT. The delay may correspond to a maximum delay time interval obtained for the TC of the respective identified TSN stream.

The wireless communication unit 802 may be adapted to receive the one or more TSN streams at the egress port from a preceding node in the TSN system and transmit the one or more TSN streams to a next node in the TSN stream through the egress port.

The memory 806 may store at least one of: the TSN streams, the TSN stream information, the maximum delay time interval of the TC to which the identified TSN streams belongs, and so on.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors, DSPs, special-purpose digital logic, and the like. The processing circuitry may be configured to execute program code stored in memory, which may include one or several types of memory such as read-only memory (ROM), random-access memory, RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

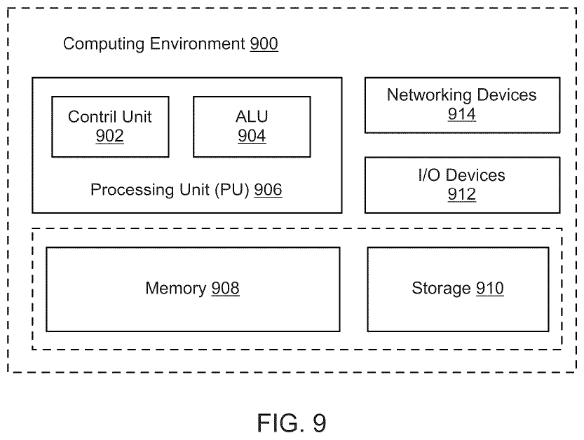

FIG. 9 illustrates an example computing environment 900 implementing a method and the apparatus, as described in FIGS. 5 and 8. As depicted in Fig., the computing environment 00 comprises at least one data processing module 06 that is equipped with a control module 02 and an Arithmetic Logic Unit (ALU) 904, a plurality of networking devices 914 and a plurality Input output, I/O devices 912, a memory 908, a storage 910. The data processing module 906 may be responsible for implementing the method described in FIG. 5. For example, the data processing module 906 may in some embodiments be equivalent to the CPU/processor/controller of the apparatus described above in conjunction with the FIG. 8. The data processing module 906 is capable of executing software instructions stored in memory 908. The data processing module 906 receives commands from the control module 902 in order to perform its processing. Further, any logical and arithmetic operations involved in the execution of the instructions are computed with the help of the ALU 904.

The computer program is loadable into the data processing module 906, which may, for example, be comprised in an electronic apparatus (such as a DS-TT or NW-TT). When loaded into the data processing module 906, the computer program may be stored in the memory 908 associated with or comprised in the data processing module 906. According to some embodiments, the computer program may, when loaded into and run by the data processing module 906, cause execution of method steps according to, for example, any of the method illustrated in FIG. 5 or otherwise described herein.

The overall computing environment 900 may be composed of multiple homogeneous and/or heterogeneous cores, multiple CPUs of different kinds, special media and other accelerators. Further, the plurality of data processing modules 906 may be located on a single chip or over multiple chips.

The algorithm comprising of instructions and codes required for the implementation are stored in either the memory 908 or the storage 910 or both. At the time of execution, the instructions may be fetched from the corresponding memory 908 and/or storage 910, and executed by the data processing module 906.

In case of any hardware implementations various networking devices 914 or external I/O devices 912 may be connected to the computing environment to support the implementation through the networking devices 914 and the I/O devices 912.

The embodiments disclosed herein can be implemented through at least one software program running on at least one hardware device and performing network management functions to control the elements. The elements shown in FIG. 9 include blocks which can be at least one of a hardware device, or a combination of hardware device and software module.

1. A method for transmission of Time-Sensitive Networking, TSN, information through a wireless communication network, the wireless communication network operating as a virtual TSN bridge of a TSN system, the method being performed by a device side TSN translator, DS-TT, associated with one or more User Equipments, UEs, connected to a network node in the wireless communication network, or by a network side TSN translator, NW-TT, associated with a User Plane Function, UPF, of a core network connected to the network node in the wireless communication network, the method comprising:
identifying one or more TSN streams being received at an ingress port of the DS-TT or the NW-TT, each of the one or more TSN streams belonging to a Traffic Class, TC;
obtaining a maximum delay time interval within the wireless communication network for the TC of the respective identified TSN stream; and
assigning to the respective identified TSN stream, a delay for transmission per TC and a port pair from the ingress port to an egress port of the DS-TT or the NW-TT, said delay corresponding to the maximum delay time interval of the TC to which the identified TSN stream belongs.

2. The method according to claim 1, wherein the assigned delay corresponding to the maximum delay time interval of the TC per port pair to which the identified TSN stream belongs relates to delay of the TSN stream within the wireless communication network.

3. The method according to claim 1, further comprising:
obtaining TSN stream information of the identified one or more TSN streams, the TSN stream information comprising gating information of a first pre-determined gating scheme and gating information of a second-predetermined gating scheme.

4. The method according to claim 1, wherein the step of obtaining the maximum delay time interval for the TC of the respective identified TSN stream comprises:
determining a TC of the respective identified TSN stream; and
obtaining the maximum delay time interval for the determined TC, the maximum delay time interval being a pre-determined value associated to the respective TC.

5. The method according to claim 1, wherein the step of assigning to the respective identified TSN stream, the delay for transmission per TC and port pair from the ingress port to the egress port of the DS-TT or the NW-TT comprises:
obtaining each frame of the respective identified TSN stream and the TSN stream information; and
assigning to each frame of the respective identified TSN stream, said delay corresponding to the obtained maximum delay time interval of the TC to which the identified TSN stream belongs.

6. The method according to claim 1, wherein the step of assigning to the respective identified TSN stream, the delay for transmission per TC and port pair from the ingress port to the egress port of the DS-TT or the NW-TT comprises:
receiving one or more TSN streams at the ingress port implementing the first pre-determined gating scheme;
determining the TC of the respective TSN stream;
storing the respective TSN stream in a pre-sorting buffer at the egress port until a next pre-determined opening time interval of a gate at the egress port starts; and
arranging, at the egress port implementing the second pre-determined gating scheme, the respective TSN stream to be transmitted from the egress port, based on mapping of the first pre-determined gating scheme within the second pre-determined gating scheme by adding the maximum delay time interval to the gating information of the first pre-determined gating scheme; and
releasing frames of the respective TSN stream from the pre-sorting buffer to the egress port for transmission based on said arrangement.

7. The method according to claim 6, wherein the step of arranging, at the egress port implementing the second pre-determined gating scheme, the respective TSN stream to be transmitted, from the egress port, comprises:
obtaining the gating information of the first pre-determined gating scheme implemented by the ingress port;
adding the maximum delay time interval to the gating information of the first pre-determined gating scheme;
mapping the first pre-determined gating scheme within the second pre-determined gating scheme implemented by the egress port in accordance with the maximum delay time interval added to the gating information of the first pre-determined gating scheme; and
delaying transmission of the respective TSN stream, at the pre-sorting buffer, until a gate at the egress port opens.

8. A Time-Sensitive Networking, TSN, translator, comprising a device side Time TSN translator, DS-TT, associated with one or more User Equipments, UEs connected to a network node in a wireless communication network or a network side TSN translator, NW-TT associated with a User Plane Function, UPF, of a core network connected to the network node in the wireless communication network configured for transmission of TSN information through the wireless communication network the wireless communication network operating as a virtual TSN bridge of a TSN system, the TSN translator being configured for:
identifying one or more TSN streams being received at an ingress port of the TSN translator, each of the one or more TSN streams belonging to a Traffic Class, TC;
obtaining a maximum delay time interval within the wireless communication network for the TC of the respective identified TSN stream; and
assigning to the respective identified TSN stream, a delay for transmission per TC and port pair from the ingress port to an egress port of the TSN translator, said delay corresponding to the maximum delay time interval of the TC to which the identified TSN stream belongs.

9. The TSN translator according to claim 8, wherein the assigned delay corresponding to the maximum delay time interval of the TC per port pair to which the identified TSN stream belongs relates to delay of the TSN stream within the wireless communication network.

10. The TSN translator according to claim 8, wherein the TSN translator is further configured for:
obtaining TSN stream information of the identified one or more TSN streams, the TSN stream information comprising gating information of a first pre-determined gating scheme and gating information of a second pre-determined gating scheme.

11. The TSN translator according to claim 8, wherein the TSN translator is configured for obtaining the maximum delay time interval for the TC of the respective identified TSN stream by:
determining a TC of the respective identified TSN stream; and
obtaining the maximum delay time interval for the determined TC, the maximum delay time interval being a pre-determined value associated to the respective TC.

12. The TSN translator according to claim 8, wherein the TSN translator is configured for assigning to the respective identified TSN stream, the delay for transmission per TC and port pair from the ingress port to the egress port of the TSN translator by:
obtaining each frame of the respective identified TSN stream and the TSN stream information; and
assigning to each frame of the respective identified TSN stream, said delay corresponding to the obtained maximum delay time interval of the TC to which the identified TSN stream belongs.

13. The TSN translator according to claim 8, wherein the TSN translator is configured for assigning to the respective identified TSN stream, the delay for transmission per TC and port pair from the ingress port to the egress port of the TSN translator by:
receiving one or more TSN streams at the ingress port implementing the first pre-determined gating scheme;
determining the TC of the respective TSN stream;
storing the respective TSN stream in a pre-sorting buffer at the egress port until a next pre-determined opening time interval of a gate at the egress port starts; and
arranging, at the egress port implementing the second pre-determined gating scheme, the respective TSN stream to be transmitted from the egress port, based on a mapping of the first pre-determined gating scheme within the second pre-determined gating scheme implemented by the egress port by adding the maximum delay time interval to the gating information of the first pre-determined gating scheme; and
releasing frames of the respective TSN stream from the pre-sorting buffer to the egress port for transmission based on said arrangement.

14. The TSN translator according to claim 13, wherein the TSN translator is configured for arranging, at the egress port implementing the second pre-determined gating scheme, the respective TSN stream to be transmitted, from the egress port, by:
obtaining the gating information of the first pre-determined gating scheme implemented by the ingress port;
adding the maximum delay time interval to the gating information of the first pre-determined gating scheme;
mapping the first pre-determined gating scheme within the second pre-determined gating scheme implemented by the egress port in accordance with the maximum delay time interval added to the gating information of the first pre-determined gating scheme; and
delaying transmission of the respective TSN stream, at the pre-sorting buffer, until a gate at the egress port opens.

15. A non-transitory computer readable medium, having thereon a computer program comprising program instructions, wherein the computer program is loadable into a data processing unit and configured to cause execution of the method according to claim 1 when the computer program is run by the data processing unit.
